(19) United States
(12) Patent Application Publication
(10) Pub. No.: US 2006/0127208 A1
(43) Pub. Date: Jun. 15, 2006

(54) Cyclic traveling apparatus and method

(76) Inventors: Stan Worthington, Cedar Falls, IA (US); Fred P. Smith, Alpine, UT (US); Fred T. Smith, Alpine, UT (US)

Correspondence Address: HUSCH & EPPENBERGER, LLC, 190 CARONDELET PLAZA, SUITE 600, ST. LOUIS, MO, 63105-3441, US

(21) Appl. No.: 11/009,818

(22) Filed: Dec. 10, 2004

(51) Int. Cl. B60P 1/00

(52) U.S. Cl. 414/517

(57) ABSTRACT

A cyclic traveling system including a rail having a plurality of engagement locations spaced there along. First and second slides may be shaped to travel along the rail. Each slide may have at least one stop selectively actuated by at least one actuator. The stops of the first and second slides may be shaped to positively engage selected engagement locations on the rail. An extension member providing extension and retraction may connect the first slide to the second slide. A control system may be operably connected to control the actuation of the actuators and the extension and retraction of the extension member in a mariner to cause the system first and second slides to travel along the rail.

### CROSS-REFERENCE TO RELATED APPLICATIONS

None.

### STATEMENT REGARDING FEDERALLY SPONSORED RESEARCH OR DEVELOPMENT

Not Applicable.

### APPENDIX

Not Applicable.

### BACKGROUND OF THE INVENTION

1. The Field of the Invention

This invention relates to facilitating powered movement of a load and more particularly, to novel systems and methods for cyclic traveling devices.

2. Related Art

Trucks in various industries have been used for many years to transport material from one location to another. Methods for loading and unloading transported material vary between industries. In many industries, transported material need not be handled with care (i.e. earth, gravel, refuse, and the like). Methods for unloading such materials include dumping, conveying, and ejecting.

Dumping is a popular method for unloading, In general, the dump truck has a frame with a bed or body mounted thereto. Typically, a tailgate forms the rear extreme of the bed. When closed, the tailgate may retain the load within the bed. When open, the tailgate may allow the load to exit the bed. Typically, to facilitate dumping, the bed may be tilted upward. As the bed tilts, the load may flow by gravity out the open tailgate. In other embodiments, the entire truck may be tilted upward to allow the load to flow from the rear of the bed.

In certain applications, dumping may be undesirable. For example, long trucks or trucks with long beds do not lend themselves to safe dumping. Typically, to effectively empty a bed, the truck or the bed must be tilted to at least a forty-five degree angle. As a result, long trucks or beds must be raised to a significant height to dump effectively. Trucks so positioned may be dangerously unstable. They may also be too high to fit under a roof of a location such as a refuse transfer station. Moreover, to accomplish the amount of tilt required, it is common to use telescopic hydraulic cylinders with multiple stages. Staged hydraulic cylinders are significant more costly to purchase and maintain than single stage cylinders.

As an alternative to dumping beds, moving or “live” floors have been incorporated in truck beds. In such configurations, movement of the floor causes the load to flow out the rear end of the bed when the tailgate is open. The movable floors are generally implemented with an endless conveyor belt or a series of moving slats. Movable floors usually require numerous and complex mechanisms that are costly to purchase and maintain. Moreover, for cargo containment, it is difficult to form a movable floor that provides a good seal to the bed. Thus, movable floor beds are limited in the types of materials they may transport.

Ejection unloading is another alternative to dumping. Ejection unloading has found wide acceptance in the refuse industry. Typically, a truck utilizing ejection unloading includes a bed with tailgate forming the rear most extreme of the bed. A movable panel extending upward and across the bed may be placed within the bed to travel back and forth along the length thereof, compacting the load during loading. Hydraulic cylinders are typically used to move the panel. During ejection, the panel is pushed from the front to the rear of the bed, thus driving and unloading the material through the tailgate.

Ejection unloading may be more costly when applied to trucks with comparatively longer beds. Longer beds require that the moving drive panel travel larger distances. As a result, staged hydraulic cylinders are usually employed. Multi-stage hydraulic cylinders are much more expensive to purchase and maintain than single stage hydraulic cylinders.

Moreover, multi-stage hydraulic cylinders, by necessity, consume more radial space than single stage cylinders capable of exerting the same force, which themselves require more axial space. As a result, significantly more bed space (axial cross section) maybe consumed by the staged hydraulic cylinder itself.

To address the space consumption problem of staged hydraulic cylinders, designers have installed staged hydraulic cylinders at an angle with respect to the length of the bed. By installing the cylinder at angle, the length required by the installation may be reduced. However, in an angled installation, only a portion of the resolved force vector exerted by the cylinder is applied to the ejection of the load. As a result, the size or bore of the cylinder must be further increased.

In other applications, pairs of staged hydraulic cylinders have been used. For example, one cylinder may angle across from the driver's side of the bed to the passenger's side of the panel as it extends rearward. A second cylinder may angle across from the passenger's side of the bed to the driver's side of the panel along its length extending rearwardly. Such configurations incorporate the disadvantages of indirect force application and the cost of two telescopic cylinders. In the refuse industry, a load is acquired in small increments, each periodically compacted with a short stroke of a panel or platen. At loading, the required hydraulic stroke for compaction is, or can be, short, but typically occurs along the truck body (bed) at a different location each time. At the end of loading, usually after transporting some distance, the panel or platen must be driven the length of the bed to discharge the load.

What is needed is a device that avoids the various stability, sealing, expense, maintenance, and space consumption problems associated with dumping, moving floors, and ejection unloading. A system is needed also to effectively handle cyclic compaction over a short stroke that may occur at different locations along the bed, while still accommodating a long unloading or expulsion motion of a panel or platen along the full length of a bed.

### SUMMARY OF THE INVENTION

The present invention may include a cyclic or “inch worm” traveling system. In one embodiment, one or two rails may extend the length of a truck bed. A first slide and a second slide may travel along the rail. In selected embodiments, the rail may have engagement locations spaced there along facilitating engagement of the first and second slides thereto. The invention may include an extension member extending from the first slide to the second slide. The extension member may be positioned so that force may be applied in the direction of travel of a load. A movable panel may be placed in the bed of a trailer or truck. The movable panel may travel along the rail at the impetus of the extension member. Due to the shorter length of the extension member, less of the bed capacity may be consumed by the extension member and movable panel (platen) of the present invention.

In operation, the first slide may engage the rail. The second slide may be selectively positioned to not engage the rail. Thus, as the extension member extends, the second slide may be increasingly spaced from the stationary first slide. Accordingly, the attached movable panel may be advanced toward the rear of the bed to compact a load or to urge a load out past a tailgate. Upon reaching full extension, the second slide may engage an engagement part, bracket, or location on the rail at a preconfigured location. The first slide may then disengage the rail. Thus, as the extension member retracts, it draws the first slide toward the now stationary second slide. Upon complete retraction of the extension member, the first slide may engage an engagement location such as a notch or hole at a preconfigured location. This cycle may repeat.

For a second cycle of travel, the second slide may then disengage the rail again. Thus, as the extension member again extends, the second slide may be increasingly spaced from the stationary first slide. Accordingly, the attached movable panel may be advanced toward the rear of the bed. This cycle may continue along the length of the bed until the entire load has been ejected by the panel or has been compressed. The cycle may be stopped in an intermediate position if a user chooses.

The panel many be retracted in a similar motion, toward the front of the vehicle. Retraction may occur to reset the platen in order to begin loading again. In certain embodiments, a platen or panel may be advanced to a new location as a load fills up and is compacted at a new location. In other embodiments, compaction motions may occur at one “door” or opening near one end of a vehicle until the load is complete and ready for discharge.

Fixed position installations of the present invention may also be constructed, as for use at a landfill or recycling center.

### BRIEF DESCRIPTION OF THE DRAWINGS

The foregoing features of the present invention will become more fully apparent from the following description and appended claims, taken in conjunction with the accompanying drawings. Understanding that these drawings depict only typical embodiments of the invention and are, therefore, not to be considered limiting of its scope, the invention will be described with additional specificity and detail through use of the accompanying drawings in which:

FIG. 1 is a partial cross-sectional, side elevation view of an embodiment of a cyclic traveling system in accordance with the present invention;

FIG. 2 is a block diagram illustrating one embodiment of a process through which a cyclic traveling system may operate in accordance with the present invention may operate;

FIG. 3 is a partial cross-sectional side elevation view of the embodiment of FIG. 1 with the first slide engaging the rail and the second slide free to travel along the rail at the impetus of the extension member;

FIG. 4 is a partial, cross-sectional, side elevation view of the embodiment of FIG. 1 with the first slide engaging the rail and the second slide traveling along the rail as the extension member extends;

FIG. 5 is a partial, cross-sectional, side elevation view of the embodiment of FIG. 1 with the second slide engaging the rail and the first slide traveling along the rail as the extension member retracts;

FIG. 6 is a partial, cross-sectional, side elevation view of the embodiment of FIG. 1 with the first slide engaging the rail and the second slide free to travel along the rail at the impetus of the extension member;

FIG. 7 is a partial perspective view of an embodiment of a cyclic traveling system wherein the first and second slides each have two pivoting stops, the first slide being illustrated with a housing and guide and the second slide being illustrated with the housing and guide removed to reveal the under workings;

FIG. 8 is a partial perspective view of an embodiment of the cyclic traveling system of FIG. 7 wherein the extension member is fully extended and the first and second slides are both illustrated with the housing and the near side guides removed to reveal the hidden workings;

FIG. 9 is a partial perspective view of an embodiment of the cyclic traveling system of FIG. 7 wherein the extension member is fully retracted and the first and second slides are both illustrated with the housing and the near side guides removed to reveal the hidden workings;

FIG. 10 is a cutaway, side elevation view of an alternative embodiment of a cyclic traveling system with the stops positioned by the actuators to permit travel to the right;

FIG. 11 is a cutaway, side elevation view of the alternative embodiment of FIG. 10 with the stops positioned by the actuators to permit travel to the left;

FIG. 12 is a cutaway, side elevation view of another alternative embodiment of a cyclic traveling system with the stops positioned by the actuators to permit travel to the right;

FIG. 13 is close-up, side elevation view of the stops and actuators of the alternative embodiment of FIG. 12;

FIG. 14 is a cutaway, side elevation view of another alternative embodiment of a cyclic traveling system with the stops positioned by the actuators to engage the top of the rail and resist travel of both the first and second slides along the rail;

FIG. 15 is a cutaway, end elevation view of another alternative embodiment of a cyclic traveling system with the stops positioned to engage apertures located in the sides of the rail;

FIG. 16 is a cutaway, side elevation view of another alternative embodiment of a cyclic traveling system with the stops positioned by the actuators to engage extensions of the rail;

FIG. 17 is a schematic diagram of an embodiment of a hydraulic system for controlling the action of an extension member in accordance with the present invention;

FIG. 18 is a schematic diagram of an embodiment of a pneumatic system for controlling the action of actuators in accordance with the present invention;

FIG. 19 is a schematic diagram of an embodiment of an electrical system for controlling the hydraulic and pneumatic systems of FIGS. 17 and 18 in accordance with the present invention;

FIG. 20 is a partial, cutaway, side elevation view of a front loading refuse truck with a cyclic traveling system in accordance with the present invention, the extension member in a retracted position;

FIG. 21 is a partial, cutaway, side elevation view of the truck of FIG. 20 with the extension member in an extended position;

FIG. 22 is a partial, cutaway, side elevation view of a rear-loading refuse truck with a cyclic traveling system in accordance with the present invention, the extension member in a retracted position;

FIG. 23 is a partial, cutaway, side elevation view of a truck having a long bed or transfer trailer with a cyclic traveling system in accordance with the present invention, the extension member in a retracted position;

FIG. 24 is a partial, cutaway, side elevation view of truck bed and “dumpster” combination having a long bed with a cyclic traveling system in accordance with the present invention having the extension member in a retracted position;

FIG. 25 is a schematic diagram of an extension member extending during an ejection cycle showing an embodiment of stop and engagement location spacing and dimensions in accordance with the present invention;

FIG. 26 is a schematic diagram of FIG. 25 with the extension member retracting during an ejection cycle;

FIG. 27 is a schematic diagram of FIG. 25 with the extension member extending during a return cycle;

FIG. 28 is a schematic diagram of FIG. 25 with the extension member retracting during a return cycle;

FIG. 29 is a front view of a two rail configuration; and

FIG. 30 is a top view of a two rail configuration.

### DETAILED DESCRIPTION OF THE PREFERRED EMBODIMENTS

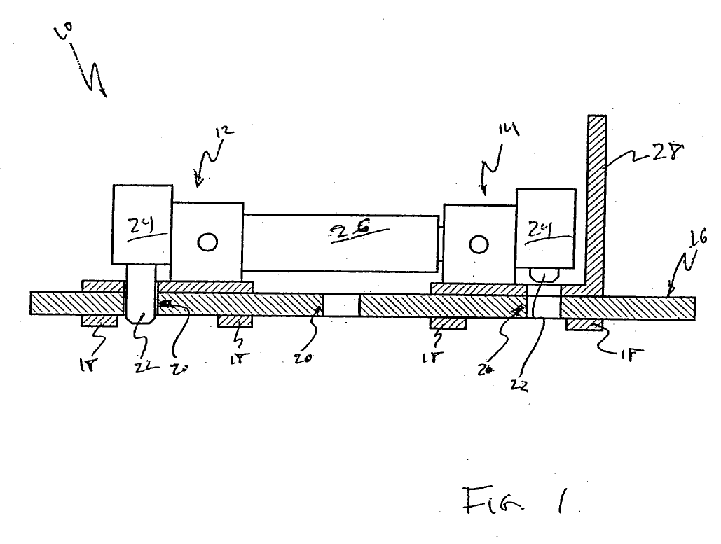

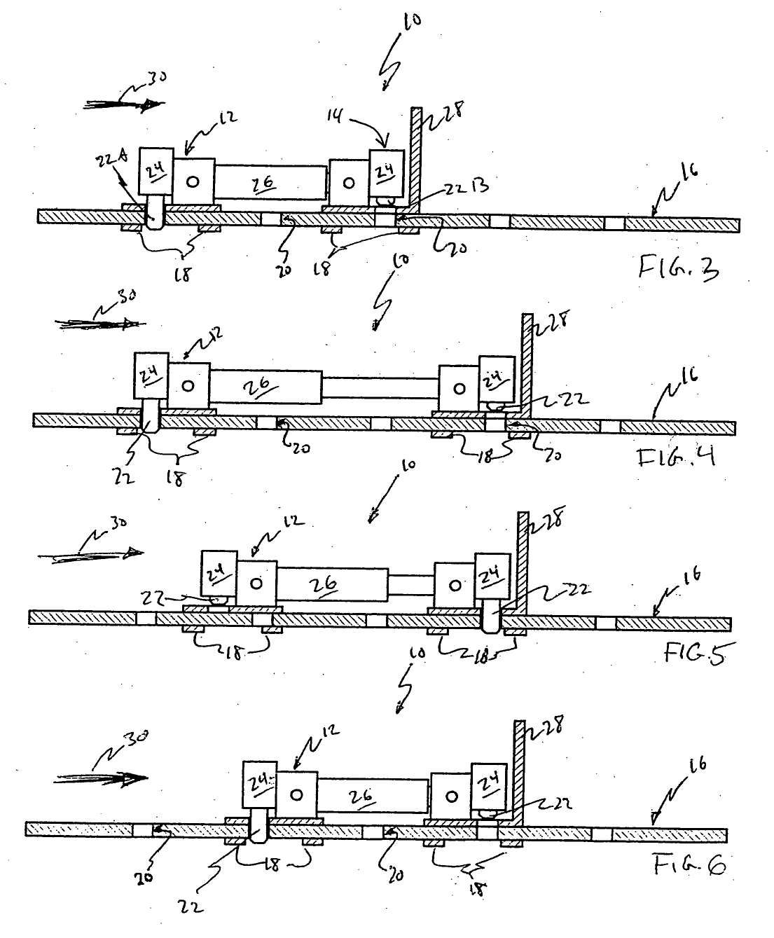

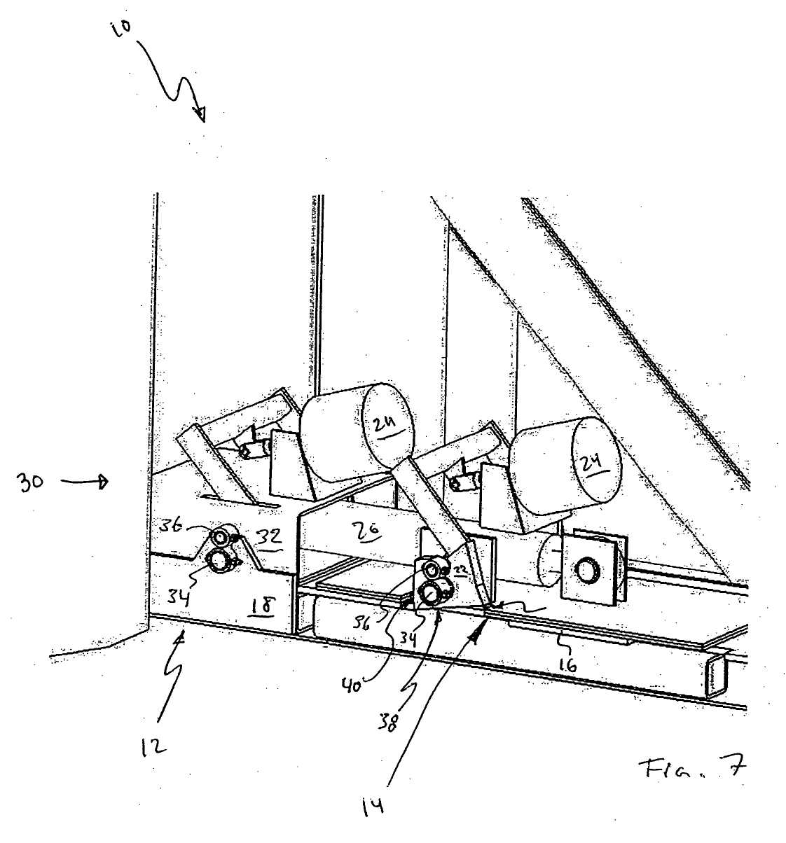

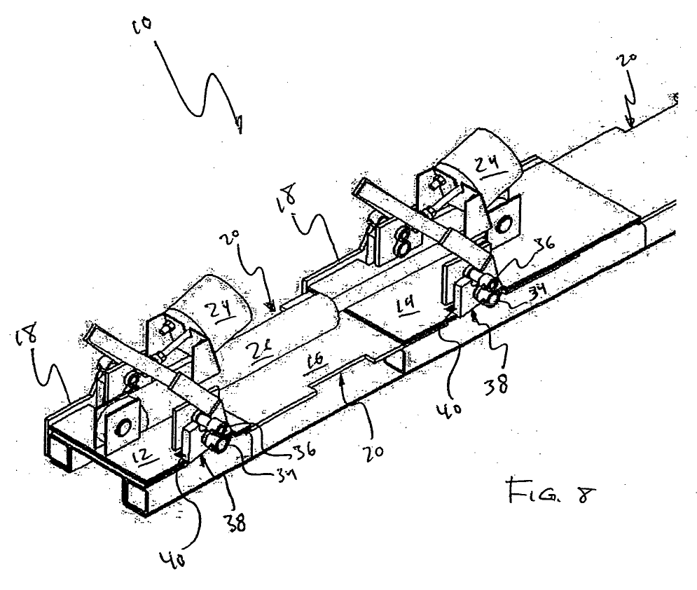

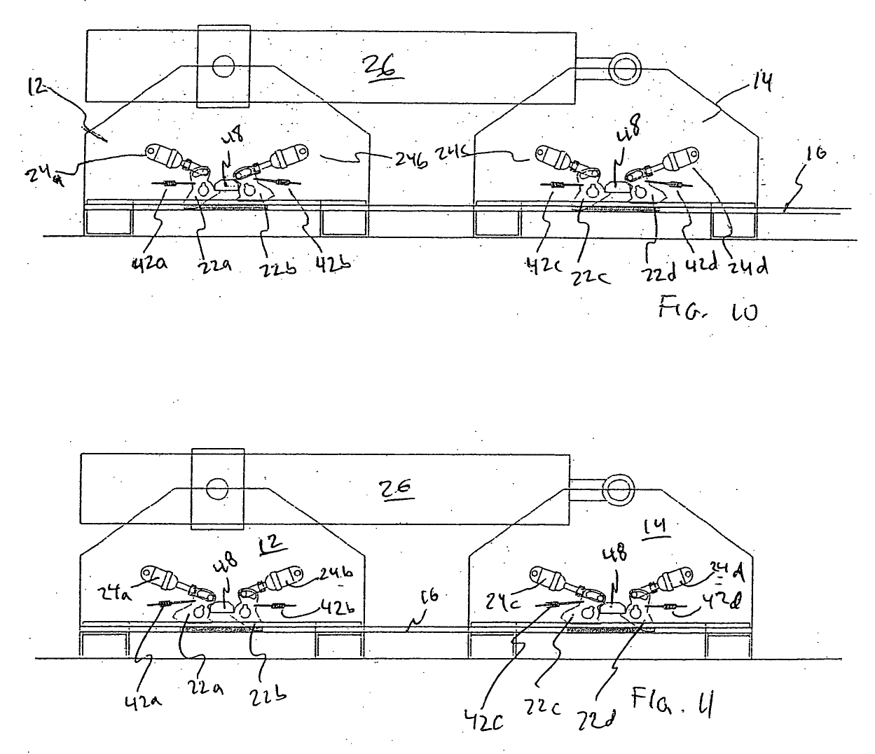

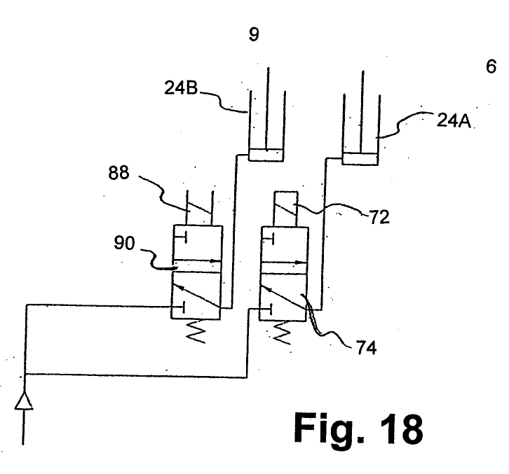

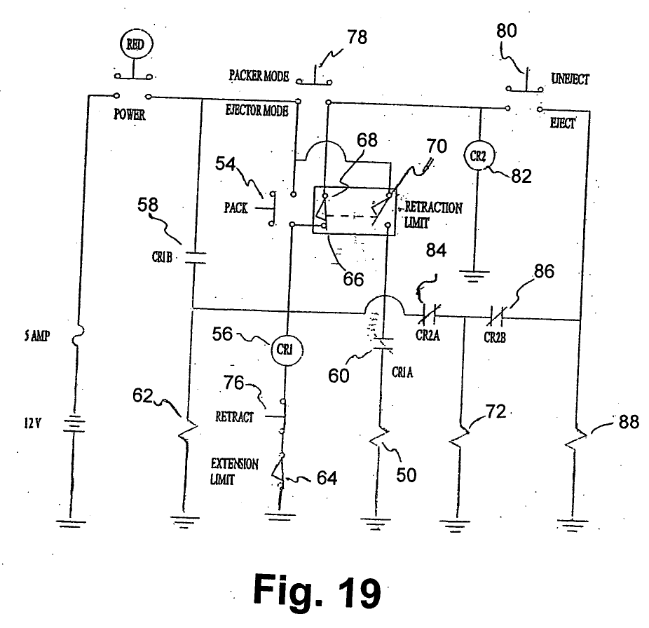

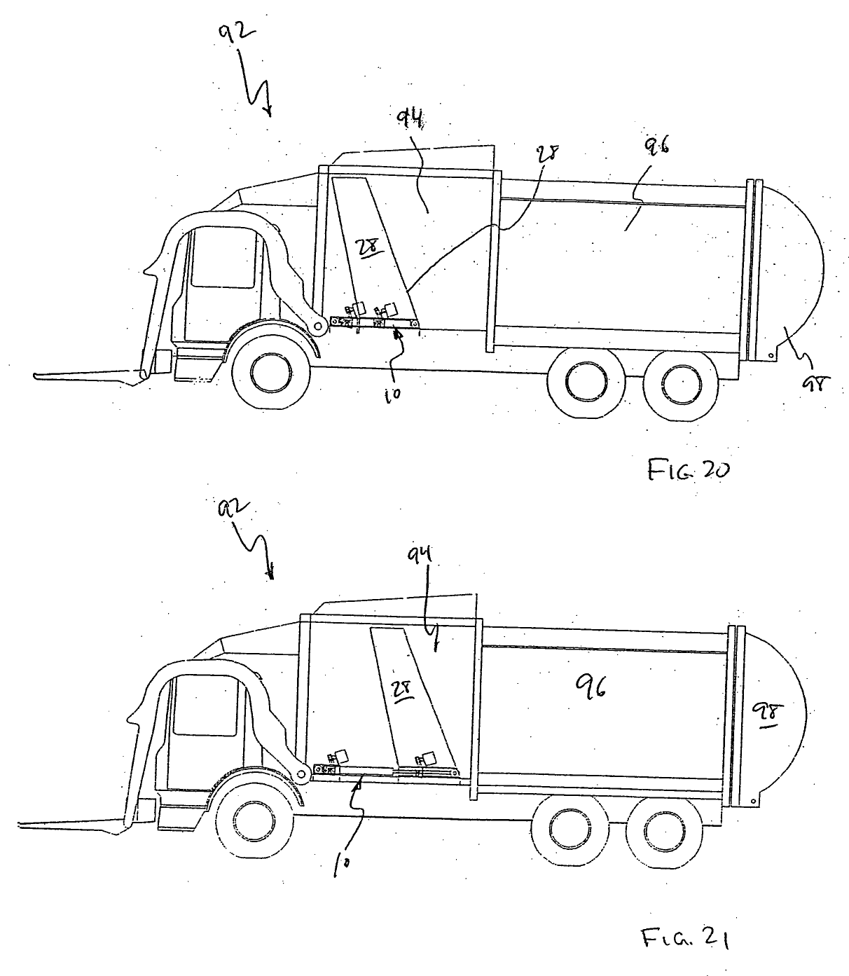

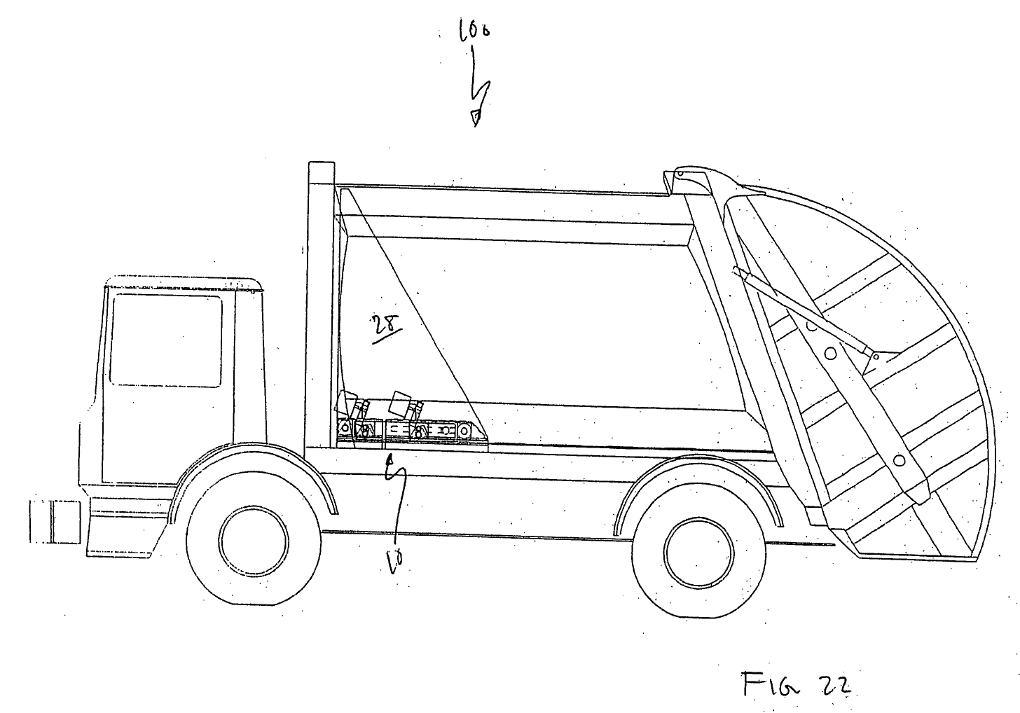

It will be readily understood that the components of the present invention, as generally described and illustrated in the Figures herein, could be arranged and designed in a wide variety of different configurations. Thus, the following more detailed description of the embodiments of the system and method of the present invention, as represented in FIGS. 1 through 28, is not intended to limit the scope of the invention, as claimed, but is merely representative of the presently preferred embodiments of the invention. The presently preferred embodiments of the invention will be best understood by reference to the drawings, wherein like parts are designated by like numerals throughout.

The present invention may be applied to a variety of applications. Suitable applications may include truck unloading, climbing (such as on a scaffold or ladder), moving loads across a floor, moving loads up an incline, and the like. The following more detailed description of various embodiments is directed to truck unloading, but may easily be adapted to other applications such as scaffold ascension and the like. The devices, rails, engagement stops and other features of all figures may represent the device as installed as such a climbing apparatus.

Referring to FIG. 1, a cyclic traveling system 10 in accordance with the present invention may include a first slide 12 and a second slide 14. The first and second slides 12, 14 may be shaped to travel along a rail 16. If desired or necessary, guides 18 may be incorporated as part of the slides 12, 14. The guides 18 may facilitate alignment and maintain contact between the slides 12, 14 and the rail 16. In certain embodiments, the guides 18 may be shaped to conform to the shape of the rail 16.

The shape and reinforcement of the slides 12, 14 and rail 16 may be selected to provide a desired structural strength. Additionally, the slide 12, 14 and rail 16 may be shaped to minimize interference with the capacity of the truck bed or other application to which the system 10 may be applied.

Slides 12, 14 and rails 16 in accordance with the present invention may be formed of any suitable material. Suitable materials may include metals, metal alloys, polymers, reinforced polymers, composites, ceramics, wood, and the like. Materials may be selected to provide the desired strength and wear characteristics. Moreover, materials may be selected to provide movement of the slides 12, 14 over the rail 16 without excessive frictional loss.

A rail 16 in accordance with the present invention may have any number of engagement locations 20 distributed there along. Engagement locations 20 or brackets 20 may be any mechanism or formation providing to the first and second slides 12 14 the ability to engage the rail 16 and resist further travel there along. The depicted engagement location 20 is a hole. Notches, detents or the like may be used. In certain embodiments, the slides 12, 14, rail 16, and engagement locations 20 may be arranged to resist inadvertent blockage by foreign objects such as trash, earth, gravel, and the like. For example, a slide 12, 14 may be shaped to sweep or push foreign objects from the rail 16 and engagement locations 20. In an alternative embodiment, a slide 12, 14 may be shaped to shear foreign objects caught in their path.

Each of the first and second slides 12, 14 may include on or more stops 22 shaped to engage the engagement locations 20 of the rail. In the depicted embodiment, the stops 22 are shear pins for insertion into the rail 16. In other embodiments, stops 22 are ratchets selectively permitting unidirectional travel of the first or second slide 12, 14 over the engagement locations 20 of the tail 16. In one selected embodiment, the stop 22 may pivot to support a ratcheting motion in both directions along the rail 16.

Stops 22 in accordance with the present invention may be controlled by one or more actuators 24. Actuators 24 may be selected from any devices capable of engaging and disengaging the stops 22 with respect to the engagement locations 20 of the rail 16. Suitable actuators 24 may operate under mechanical motivation, electrical motivation, or any combination thereof. For example, an actuator 24 may be a spring brake actuator extending under pneumatic or hydraulic impetus and retracting under spring impetus. In other embodiments, an actuator 24 may be a solenoid with a return spring or a double-acting solenoid. In one embodiment, an actuator 24 may include two solenoids, one to engage the stop 22 and one to disengage the stop 22.

An extension member 26 may extend from the first slide 12 to the second slide 14. An extension member 26 in accordance with the present invention may be any member capable of controlled extension and contraction. An extension member 26 may operate by hydraulic pressure or any other mechanical or electrical mechanism.

A rail 16 in accordance with the present invention may be shaped or formed in a manner corresponding to the extension member 26. For example, if the extension member 26 is hydraulically operated, the rail may be formed to house, shield, receive, align, dispense or otherwise control the hydraulic hoses that may require access to the extension member 26 at a variety of locations along the rail 16.

A panel 28 may secure to one of the first and second slides 12, 14. The configuration of the panel 28 may vary from application to application. For example, a panel 28 for use in unloading a truck bed may have a height and width corresponding to the truck bed. Thus, as the system 10 propels the panel 28, the contents of the truck bed may be selectively compacted or ejected. If applied to scaffold climbing, the system 10 may include a panel 28 facilitating engagement of a walkway, or the like, to be ascended.

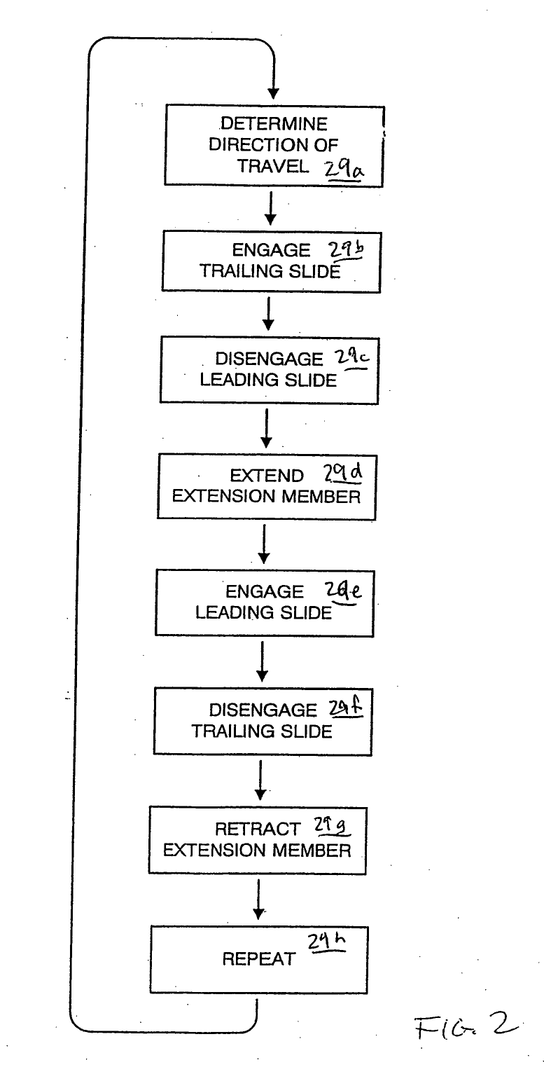

Referring to FIGS. 2-6, a cyclic traveling system 10 in accordance with the present invention may operate by first making a determination 29a of the direction of travel 30. The trailing slide 12 and the leading slide 14 may then be assigned to correspond to the direction of travel 30. The trailing slide 12 may then engage 29b the rail 16 while the leading slide 14 disengages 29c the rail 16. As depicted, engagement is by downward vertical extension of stop pins 22A and/or 22B. Extension is by actuators 24. As the extension member 26 begins to extend, the trailing slide 12 may be held stationary and the leading slide 14 begins to advance along the rail 16. The leading slide 14 may advance in a ratcheting motion or may simply advance to a desired position corresponding to an engagement location 20.

Upon reaching maximum extension 29d or an alignment with a selected engagement location 20, the leading slide 14 may engage 29e the rail 16 by stop pin 22B. The trailing slide 12 may disengage 29f from its fixed position to be able to move along the rail 16. Thus, as the extension member 26 retracts, the leading slide 14 is held stationary while the trailing slide 12 advances. The trailing slide 14 may advance in a ratcheting motion or may simply advance to a desired position corresponding to an engagement location 20.

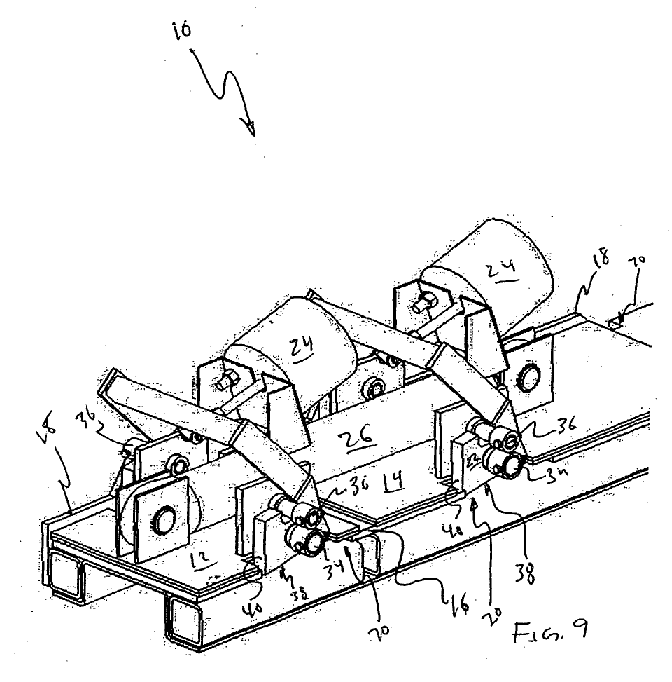

Upon reaching maximum retraction 29g or an alignment with a selected engagement location 20, the trailing slide 12 may engage the rail 16. The leading slide 14 may then disengage the rail 16 and be free to again advance along the rail 16 as the extension member 26 again extends. This process may be repeated 29h until the panel 28 has moved the desired distance. To move in the opposite direction, the designations of leading and trailing slides may be reassigned and the same process may be followed until the panel 28 has returned to the desired location An alternative embodiment is depicted on FIGS. 7-9. Actuators 24 in accordance with the present invention may have any suitable orientation. If desired, more than one stop 22 may be manipulated by a single actuator 24 such as in pairs transverse to the rail 16. In such embodiments, the stops 22 may be connected to move together. If desired or necessary, housings 32 may be applied to the slides 12, 14 to provide protection and to resist penetration of objects or materials that may inhibit operation of the system 10. In certain embodiments, stop 22 may be used in tandem. Thus, each slide 12, 14 may contain two stops 22. If desired, more than two stops 22 may be applied to each slide 12, 14.

In selected embodiments, stops 22 may rotate about a pivot 34. In such an embodiment, an actuator 24 on a slide 12, 14 may rotate a stop 22 to slide on the surface of the rail 16. Upon reaching an engagement location 20, the stop 22 may pivot fully. The stop 22 may be spring biased towards an engaged position. A limiter 36 may control the extent of such pivoting. In an alternative embodiment, the actuator may hold a stop 22 in a neutral position. In such a configuration, rotation of the stop 22 may be accomplished upon reaching an engagement location 20. Such an arrangement may remove the “clicking” noise normally associated with a ratcheting engagement.

A fully pivoted stop 22 may present a ramp 38 in the direction of travel 30 and a block 40 in the opposite direction. The ramp 38 may induce a disengaging rotation of the stop 22 upon contact with the engagement location 20 as the apparatus is extended. Thus, the stop 22 may exit the engagement location in the direction of travel 30. However, the block 40 may resist exit of the stop 22 from the engagement location 20 in a direction opposite to the direction of travel 30.

When travel in the opposite direction is desired, an actuator 24 may rotate the stop 22 to present a ramp 38 in the new direction of travel and a block 40 in the opposite direction. By pivoting the stops 22, the permitted direction of travel and the prohibited direction of travel may be switched.

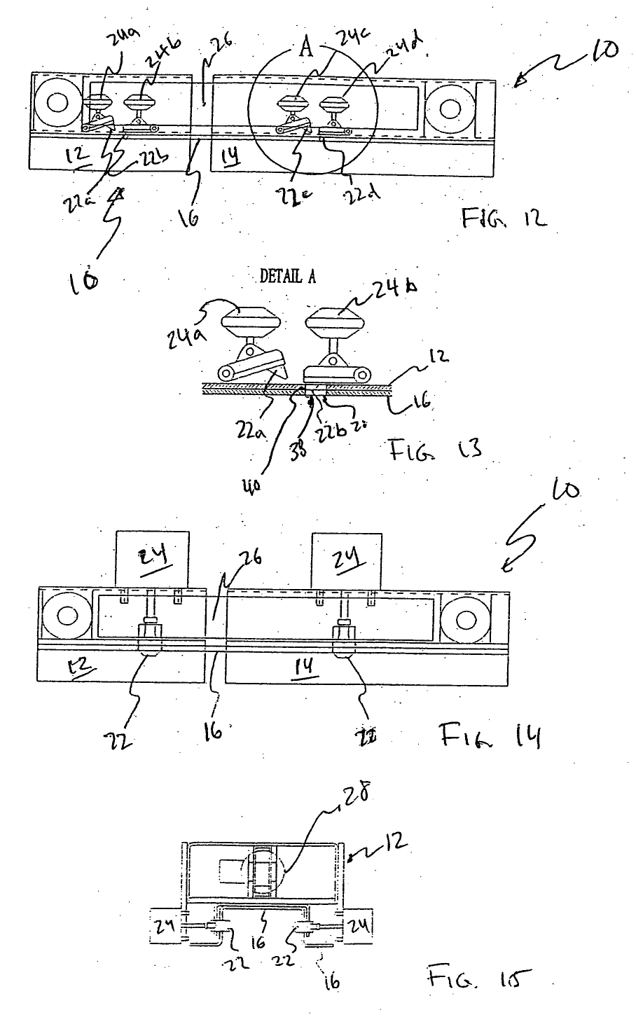

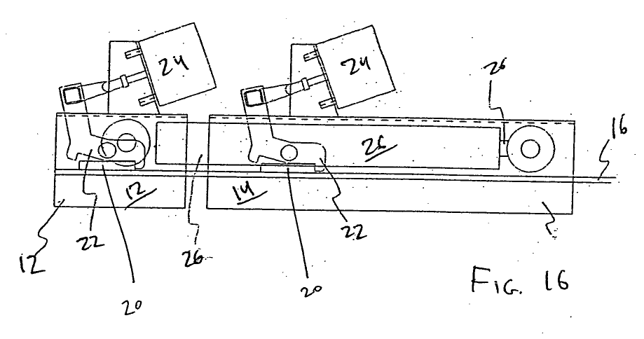

Referring to FIGS. 10 and 11, a stop 22 in accordance with the present invention may incorporate a variety of forms. For example, a first slide 12 may include pivotably mounted stops 22a, 22b in a pair aligned with a direction of travel. Similarly, a second slide 14 may also include a multi pair of pivotably mounted stops 22c, 22d.

To permit travel in a desired direction 30, a first actuator 24a may be turned off, permitting a first spring 42a to rotate a first stop 22a to a locked position 44a. A second actuator 22b may be turned on to overcome a second spring 42b and rotate a second stop 22b to an unlocked position 46. Similarly, a third actuator 24c may be turned off, deactivated, or otherwise disengaged, permitting a third spring 42c to rotate a third stop 22c to a locked position 44b; A forth actuator 22d may be activated, engaged, operated, or switched on to overcome a forth spring 42d and rotate a forth stop 22d to an unlocked position 46b. Abutments 48 may be provided to generate interference between the stops 22a, 22c and the rail 16.

To permit travel in the opposite direction, actuators 22b, 22d that were activated or turned on may be deactivated or turned off, and actuators 22a, 22c that were deactivated (turned off) may be turned on reactivated. Slots 25 may be provided in the stops 22a, 22b, 22c, 22d to provide proper clearances and rotation.

Referring to FIGS. 12 and 13, stops 22a, 22b, 22e, 22d may be selectively pivoted into engagement locations 20 formed as apertures or notches in the rail 16. The stops 22 may each include a ramp 38 and block 40 to support unidirectional travel of the slides 12, 14 as discussed hereinabove.

Referring to FIGS. 14 and 15, stops 22a, 22b may be selectively inserted into engagement locations 20 formed as apertures in the rail 16. In such an embodiment, the stops 22 may function as shear pins selectively resisting travel of the slides 12, 14 along the rail 16. Stops 22 in accordance with the present invention may engage the rail 16 in any suitable orientation. In certain embodiments, the slops 22 may engage engagement locations 20 located on the top of the rail 16. In other embodiments, the stops 22 may engage engagement locations located on the sides of the rail 16.

Referring to FIG. 16, in an alternative embodiment the engagement locations 20 may be extensions, blocks or bosses. Rather than engaging concave apertures or notches, stops 22 in accordance with the depicted embodiment may be concave themselves to engage convex engagement locations 20 formed as extensions or bosses. Such stops 22 may pivot to accomplish the desired selective unidirectional motion of the slides 12, 14.

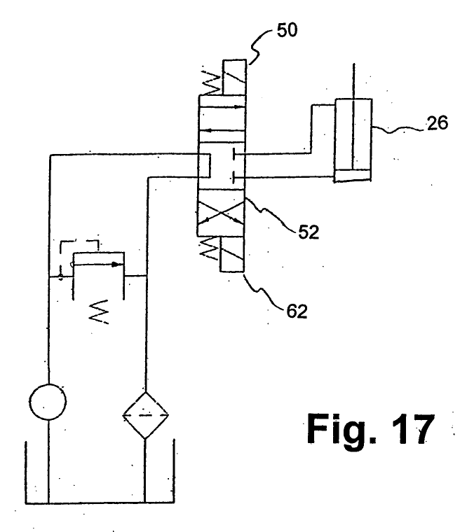

Referring to FIGS. 17-19, control of actuators 24 and extension members 26 in accordance with the present invention may be accomplished in any suitable manner. Suitable methods may include electrical control, pneumatic control, hydraulic control, mechanical control, and any combination thereof.

In selected embodiments, both packing and ejection cycles may be incorporated in a control system. A packing cycle may be a single extension and retraction of the extension member 26 wherein one of the slides 12, 14 never relocates on the rail 16. If more extensive packing is desired, particularly in mostly empty beds, packing cycles may involve travel of the system 10. An ejection cycle may include multiple extensions and retractions of the extension member 26 until the panel 28 pushes all material from the bed.

Packing cycles may be used in the refuse industry to compact trash and clear space for more trash. Packing cycles may be relatively rapid since the entire system 10 may not have to travel. That is, the panel 28 may simply clear an entrance region for inputs of refuse, compacting only as necessary therefore. Once the bed is full, an ejection cycle may push the entire load of trash from the bed.

In a packing cycle for one embodiment, a first solenoid 50 may be energized and a four-way, three-position valve 52 may shift. As a result, the extension member 26 may retract. When a “pack” momentary contact switch 54 is depressed, a first relay 56 may be energized, a first contact 58 may be closed, and a second contact 60 may be opened. A second solenoid 62 may then be energized and the first solenoid 50 may be deactivated. This may cause the four-way, three-position valve 52 to shift, resulting in the extension of the extension member 26.

An extension limit switch 64 may be closed and remain closed until the extension member 26 reaches maximum extension. A double pole, retraction limit switch 66 may have a first pole 68 and a second pole 70. The first pole 68 may be initially closed and the second pole 70 may be initially open. As the extension member 26 begins to extend, the double pole, retraction limit switch 66 shifts and the first pole 68 may open while the second pole 70 may close.

In the packing cycle, a third solenoid 72 may be energized and a first three-way, two-position valve 74 may shift, applying pressure to an actuator 24a located on the leading slide. Thus, while the rear stop remains engaged to anchor the apparatus, the lead slide is freed so that the platen may be driven to pack the material.

At any time during extension, the “retract” momentary contact switch 76 may be depressed. This may open the first contact 58 and close the second contact 60. Thus, the first solenoid 50 may be activated while the second solenoid 62 is deactivated. With the first solenoid 50 active, the four-way, three-position valve 52 may shift and the extension member 26 retract.

If the packer mode is allowed to run, the extension member 26 may fully extend, the extension limit switch 64 may open, and the first relay 56 may become inactive. This may open the first contact 58 and close the second contact 60, thereby, energizing the first solenoid 50 and deactivating the second solenoid 62. With the first solenoid 50 active, the four-way, three-position valve 52 shifts, the extension member 26 retracts, and the extension limit switch 64 closes. When the extension member 26 retracts completely, the retraction limit switch 66 may shift and the first pole 68 may close while the second pole 70 opens. Thus, a pack cycle may be completed and both the first and second solenoids 50, 62 may be left inactive.

In certain embodiments, the control system may also support an ejection mode. To eject, a mode switch 78 may be switched from “pack mode” to “eject mode.” Similarly, a direction switch 80 may be set for “eject.” At such settings, a second relay 82 may be energized, a third contact 84 may open, and a forth contact 86 may close. A fourth solenoid 88 and the third solenoid 72 maybe energized. As a result, a second three-way, two-position valve 90 as well as the first three-way, two-position valve 74 may shift to apply pneumatic pressure to the actuators 24a, 24b.

The first relay 56 may be energized, the first contact 58 may be closed, and the second contact 60 may be opened. As a result, the second solenoid 62 may then be energized while the first solenoid 50 is deactivated. This may cause the four-way, three-position valve 52 to shift, resulting in the extension of the extension member 26.

As the extension member 26 extends, the extension limit switch 64 may remain closed until full extension is achieved. The first pole 68 of the double pole, retraction limit switch 66 may be initially closed and the second pole 70 may be initially open. As the extension member 26 begins to extend, the retraction limit switch 66 may shift and the first pole 68 open while the second pole 70 closes. When the extension member 26 reaches maximum extension, the extension limit switch 64 may open and the first relay 56 may become inactive. This may open the first contact 58 and close the second contact 60. Thus, the first solenoid 50 may be energized while the second solenoid 62 may be deactivated.

With the first solenoid 50 active, the four-way, thee-position valve 52 may shift causing the extension member 26 to retract and the extension limit switch 64 to close. When the extension member 26 retracts completely, the cycle may begin again and continue until the direction switch 80 is moved to “uneject.” The direction switch 80 may be toggled manually or triggered by reaching the end of the rail 16.

In the “unejected” direction, a second relay 82 may be energized, a third contact 84 may open, and a forth contact 86 may close.

A forth solenoid 88 as well as the third solenoid 72 may be deactivated causing a second three-way, two-position valve 90 as well as the first threeway, two-position valve 74 to release pressure from the actuators 24a, 24b. The extension member 26 may continue in the cycle of extension and retraction as outlined hereinabove. Because the stops 22 have rotated into engagement, the system 10 begins to move forward.

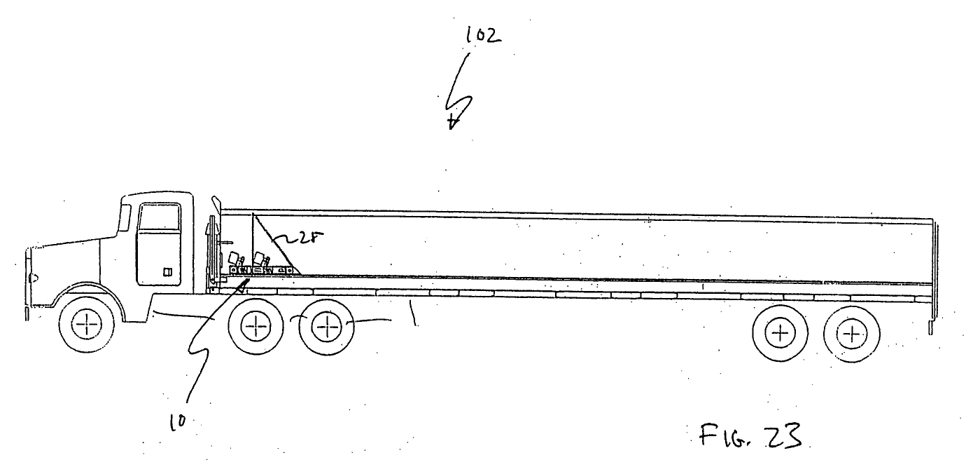

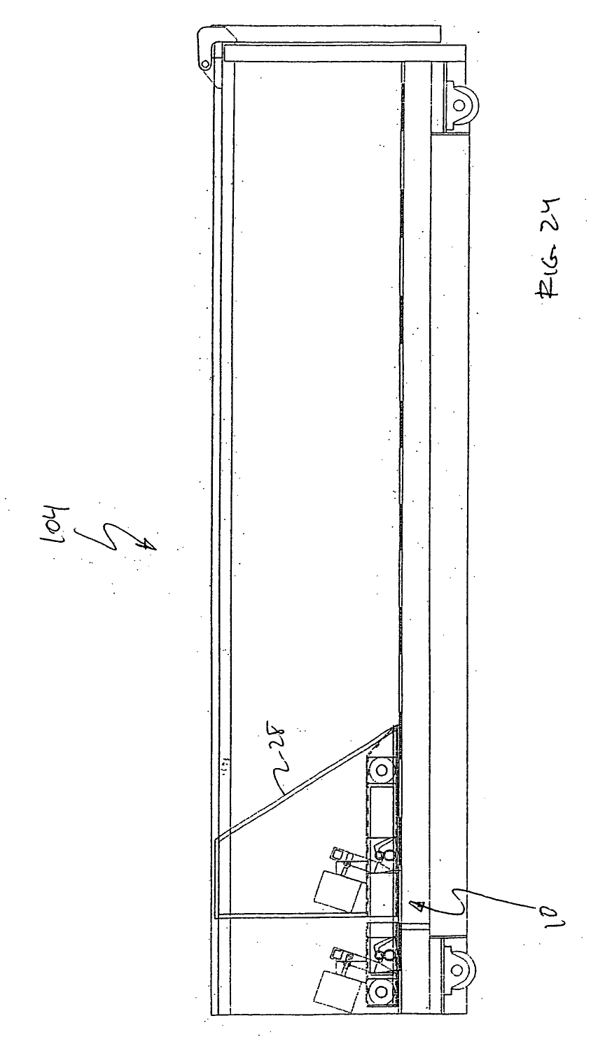

Referring to FIGS. 20 and 21, certain embodiments in accordance with the present invention may be applied to a front-loading refuse truck 92. In such an application, the cyclic traveling system 10 may push a panel 28 rearward to pack a load into the bed 96 of the truck 92. In the pack cycle, the second slide 14 may be pushed rearward, thereby packing the load from the hopper 94 into the body 96 of the refuse truck 92. After the load is packed, the extension member 26 may retract the panel 28 so additional trash may be placed in the hopper 94. The panel 28 attached to the second slide 14 may be shaped to match the cross section of the body 96. Thus, as the panel 28 is propelled rearward by the cyclic traveling system 10, the load may be packed over the entire cross section of the body 96.

A cyclic traveling system 10 may also eject the load from a front-loading refuse truck 92. When the body 96 is full, a tailgate 98 may be opened permitting the load to be ejected from the rear of the body 96.

Referring to FIGS. 22-24, certain embodiments in accordance with the present invention may be applied to a rear-loading refuse truck 100, a transfer trailer 102, or a stationary dumpster 104. Although the present invention has been disclosed and illustrated with reference to particular embodiments, the principles involved are applicable to numerous applications. A system requiring linear movement horizontally, vertically, or otherwise may employ a cyclic traveling system 10 in accordance with the present invention.

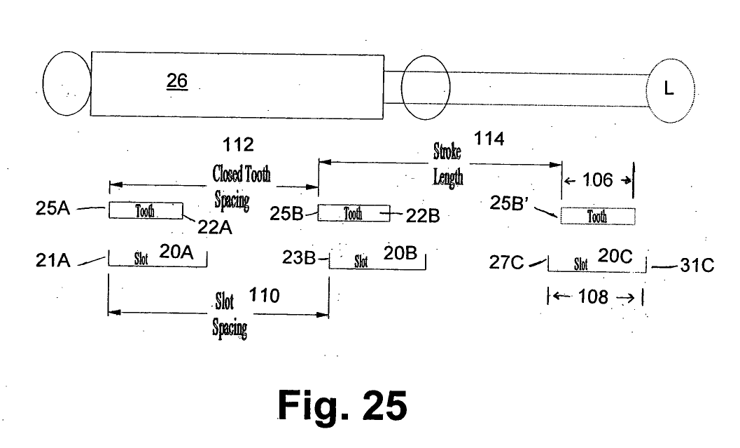

Referring to FIGS. 25-28, to place a tooth (stop) 22 exactly over a slot (engagement location) 20, it may be desirable to provide a predetermined sizing of engagement locations 20 and spacing of the engagement locations 20 along the rail 16. For example, to allow for fabrication tolerances, rotation, and movement, the length 108 of the engagement locations 20 may be greater than the length 106 of the stops 22. In one example, if each tooth 22 is 6 inches long, the length 106 of a tooth slot 20 is the length of the tooth plus two inches.

In certain embodiments, the slot spacing 110 of engagement locations 20 may be slightly greater than the spacing closed tooth 112 of the teeth 22 when the extension member 26 is retracted. In one example, if the closed tooth spacing 112 is 17 inches, the slot spacing 110 may be 18 inches equal to the closed tooth spacing 112 of the teeth 22 when the extension member 26 is retracted plus one inch.

In certain embodiments, the stroke length 114 of the extension member 26 may be slightly greater than the closed tooth spacing 112 of the teeth 22 when the extension member 26 is retracted. In one example, the stroke length 114 of the extension member 26 may be selected or adjusted to be three inches longer than the closed tooth spacing 112 of the teeth 22 when the extension member 26 is retracted.

In general, the smaller the closed tooth spacing 112 of the teeth 22 when the extension member 26 is retracted, then the greater number of cycles may be needed to reach the end of the rail 16. As a result, travel time may be increase. On the other hand, the larger the closed tooth spacing 112 of the teeth 22 when the extension member 26 is retracted, the fewer number of cycles may be needed to reach the end of the rail 16, thus shortening travel time. However, the apparatus space is increased and available load space correspondingly decreased.

When there are more engagement locations 20 on the rail 16 than may be necessary, the process of alignment may be simplified. If a stop 22 does not align with an engagement location 20, then, when the extension member 26 begins to extend or contract, the misaligned stop 22 will slide back along the rail 16 until proper engagement is acquired at a next shorter stop. The travel lost due to sliding stops 22 may, however, increase the cycle time of the system 10.

Formulas and Relations:

One embodiment of the present invention is dimensioned according to these formulas:

Closed Tooth Spacing 112+Stroke 114≧2 * Slot Spacing 110

This places lead tooth into advance slot 200 with a reasonable tolerance.

Slot Length 108≧Tooth length 106

Slot Spacing 110≧Closed Tooth Spacing 112

Again these dimensions maintain a tooth slot engagement tolerance that is durable and robust, but does not sacrifice any unreasonable amount of throw length. In one embodiment, Slot length=Tooth length+2 inches.

The Stroke Length, Closed Tooth Spacing and Slot Spacing have direct relationship. If Slot Spacing were greater than Closed Tooth Spacing by too much, 2″ or more in the example embodiment herein described, the invention does not place the tooth exactly into the next slot. When Slot Spacing is less than Closed Tooth Spacing by 2″ or more, the invention also does not place the tooth exactly into the next slot. When the Slot Spacing is equal to the Closed Tooth Spacing, the invention does not reliably place the tooth exactly into the next slot. Accordingly, an ideal relationship in the example embodiment is that the Slot Spacing=Closed Tooth Spacing+1 inch.

If the Stroke Length in the example dimensions were greater than the Closed Tooth Spacing by 4″ or more, the “dog” tooth would surpass the next needed slot. However the “dog” tooth would be brought back into the correct slot as the cylinder retracts. The cycle time would increase because of how much extra travel the “dog” tooth does in order to be positioned in the next slot. If the Stroke Length is less than or equal to the Closed Tooth Spacing, the invention would not place the tooth exactly into the next slot. The ideal stroke length needs to be 3″ greater than the Closed Tooth Spacing, relative to dimensions in the example.

Accordingly, Stroke Length=Closed Tooth Spacing+3. The closed tooth spacing is related to the length of the track such that a smaller closed tooth spacing creates a larger number of cycles needed to reach end of track and longer amount of time to empty body. Longer Closed Tooth Spacing means a shorter amount of time to empty body.

When there are more slots in the track than needed different relations of the above equations may be allowed. The “dog” teeth will not be placed in the next slot exactly, but will fall back into a previous slot. The cycle time is increased. The number of slots needed in the track is increased.

Dimension Example
INPUTS:

| | |
|---|---|
| Tooth Length | 6 |
| Slot Length | 8 |
| Stroke Length | 20 |
| Closed Tooth Spacing | 17 |
| Slot Spacing | 18 |

EJECTING
Extending:

| | |
|---|---|
| Front tooth gap at back of 2nd slot <= 0 OK | −1 |
| Front tooth gap at front of 2nd slot <= 0 OK | 3 |

After 1 extension

| | |
|---|---|
| Front tooth gap at rear of 3rd slot | 1 |
| Front tooth gap at front of 3rd slot <= 0 OK | 1 |

Retracting:

| | |
|---|---|
| Rear tooth Gap at rear of 2nd slot | 1 |
| Rear tooth Gap at front of 2nd slot <= 0 OK | 1 |

To place the “dog” tooth in the middle of the slot in both the ejecting and retracting:

1. Pick a Stroke Length

2. Pick a Gap (X)

3. Use these equations:
Stroke−3* X=ClosedToothSpacing
SlotSpacing=ClosedToothSpacing+X

In operation, as illustrated in FIG. 25 through 28, the proper dimensional interrelationship of the components works as follows. FIG. 25 depicts a beginning position of the cylinder before an eject cycle. The piston rod is extendable to the right, where it is resisted by the force of the load. The previously disclosed the extending cylinder 26 is connected to a back stop or tooth 22A and a front stop or tooth 22B. The tooth, or teeth, are mounted on or configured as a slide in any of the embodiments previously shown. The extending cylinder/slide assembly is disposed to engage the rail containing a series of slots (engagement locations) of which the first three are depicted in FIGS. 25 through 28, including a first slot 20A, a next or second slot 20B and a third slot 20C.

In the beginning or rest position depicted in FIG. 25, the back tooth 22A is disposed within a first slot 20A. In the depicted position, a back vertical engaging face 23A of tooth 22A is flush with a back vertical engaging face 21A of slot 20A. This engagement will provide a stop against which the cylinder 26 can forcefully extend the load (“L”) towards the right when extending. The front tooth 22B (sometimes known as the “dog tooth” by those with skill in the art) may be disposed within slot 20B, which would require that it be removed, as by the actuation of the solenoid, from slot 20B before extension. Alternatively, and as depicted in FIG. 25, front tooth 22B may rest in a vertically retracted position. In such a position, front tooth 22B may be disposed entirely over a second slot 20B, may have its back engaging face 25B flush with a back engaging face 23B of second slot 20B, or may have its back engaging face 25B to the rear (or to the left in FIG. 25) of back engaging face 23B of slot 20B. In the position depicted in FIG. 25, which is in accordance with examples and formulas disclosed herein for an efficient embodiment, front tooth 22B is in vertically retracted position, and its back engaging face 25B is to the rear of the slot back engaging face 23B, because the back tooth 22A is as far to the rear as possible. When back tooth 22A is as far to the rear as possible, front tooth 22B may be as far forward as having its rear engaging face 25B flush with the rear engaging face 23B of second slot 20B.

Upon engagement of the extending cylinder 26, the load is pushed forward, to the right in FIG. 25, against the resistance provided by the back tooth rear engaging face 25A against the rear engaging face 21A of the first slot 20A. The front tooth 22B travels to extended position 22B′. Because of the preconfigured relationship of the closed tooth spacing 112, slot spacing 110 and stroke length 114, the extended position of the front tooth 22B′ is entirely over the third slot 20C, so that the front tooth 22B may be actuated for downward extension into the third slot 20C. As dimensioned, moderate gaps exist both between the rear engaging face 25B′ of the front tooth 22B and the rear engaging face 27B of third slot 20C and also between a front engaging face 29B of front tooth 22B and front engaging face 31C of third slot 20C. The front tooth 22B is vertically extended into slot 20C.

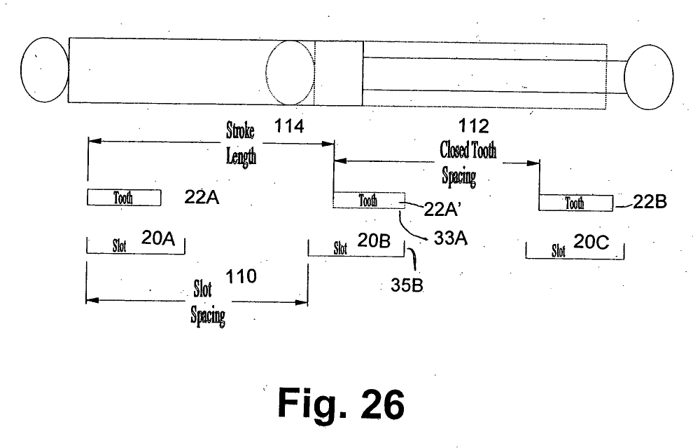

In operation a next step will be for the apparatus to draw its rear tooth forward or to the right in FIG. 26 until it engages with the second slot 20B. In so doing, retraction of the cylinder 26 will draw the rear engaging face 25B′ of front tooth 22B′ against the rear engaging face 27C of slot 20C. This engagement provides resistance against which the cylinder can draw rear tooth 22A forward. In so moving, the cylinder will travel through its length where upon it will stop in a position that places rear tooth 22A over slot 20B. The dimensional relationship between the slots spacing 110, closed tooth spacing 112 and stroke length 114 will thereby place a front engaging face 33A of back tooth 22A either flush with or to the rear of a front engaging face 35B of second slot 20B. There upon, an actuator will vertically displace rear tooth 22A downwards into a position engaged with second slot 20B.

Upon a next extending cycle, extension of the cylinder will drive the rear tooth 22A rearwards until its rear engaging face 25A contacts a rear engaging face 23B of second slot 20B. This engagement will provide the resistance against which the now vertically retracted front tooth 22B, as well as the load, can be displaced forward another step. This cycle repeats until the load is either compressed or disposed of.

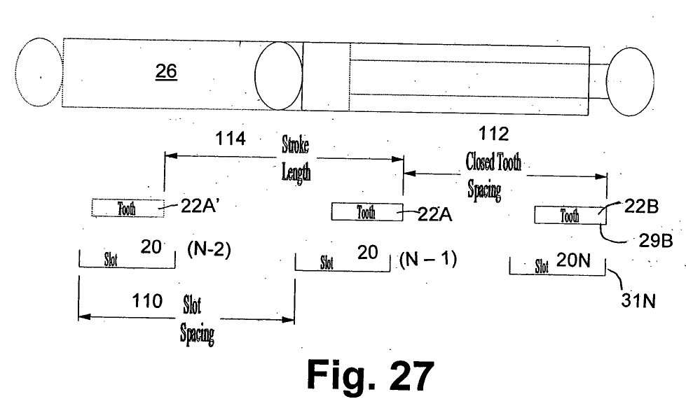

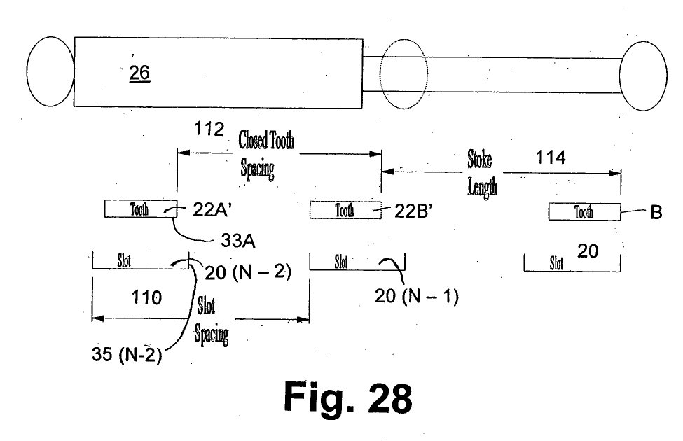

In order to retract the apparatus to its original rest position so that the garbage truck or other haul vehicle is open and ready for reloading, the process is essentially reversed. FIG. 27 depicts the apparatus at a forward state. Front tooth 22B now acts in a manner analogous to the rear tooth 22A in the extending cycle. Tooth 22B has a forward engaging face 29B which engages a forward engaging face 31N of the final slot 20N. This provides resistance against which the extending cylinder can push the rear tooth 22A rearward, or to the left in FIGS. 27 and 28. As in its mirror image cycle described above, the rear tooth 22A may be in an engageable position relative to the open slots 20 (N-1) or, a marginal distance forward of it. In any case, it is vertically retracted in order to execute the first step of the return cycle. Extension of cylinder 26 will drive the rear tooth 22A to the rear of the vehicle and to the left in FIGS. 27 and 28 until the cylinder 26 is fully extended. The relative dimensions of the slot facing 110, closed tooth spacing 112 and stroke length 114 will necessarily place rear tooth 22A′ in a position which is engageable over slots 20 (N-2). The rear tooth 22A is vertically extended to engage slots 22 (N-2). Thereafter, a forward engaging face 33A of rear tooth 22A will engage a forward engaging face 35 (N-2) of the slot in order to provide resistance against which the retraction of cylinder 26 can draw the forward tooth 22B from its position over the final slot 22N and to the rear. Upon the cylinder being fully contracted, the dimensional relationships a position of the forward tooth 22B in position 22B′ over slot 20 (N-1). The forward tooth 22B can then be vertically extended for engagement with slot 20 (N-1), where it will anchor a next rearward extension of the cylinder for a next cycle. This cycle repeats until the apparatus is again at its rest or fully open position.

Of course, various embodiments of the present invention, and the position of the apparatus is selectable so that an operator can stop the apparatus in any slot. This allows the operator to open the haul vehicle cargo space door, and eject from it or leave the door closed and compress a load against it to whatever degree is necessary.

The gaps and tolerances disclosed herein are an efficient embodiment of the present invention, particularly as it is applied in haul trucks such as garbage trucks. Other relative dimensions remain within the scope of the present invention. Of course the apparatus of the present invention may be dimensioned in other sizes in order to perform work of a larger capacity, as for example in mining, or for smaller capacity. Normalization of the dimensions given in the example above yield a scaleable efficient embodiment characterized by the following ratios and preferred ranges.

| | Ratio | Range |
|---|---|---|
| Tooth Length to Slot Length | .75 | 0.8-0.9 |
| Closed Tooth Length to Stroke Length | 0.85 | 0.8-0.9 |
| Closed Tooth Length to Slot Space | 0.95 | 0.9-1.0 |
| Slot Spaced to Stroke Length | 0.9 | .08-1.0 |

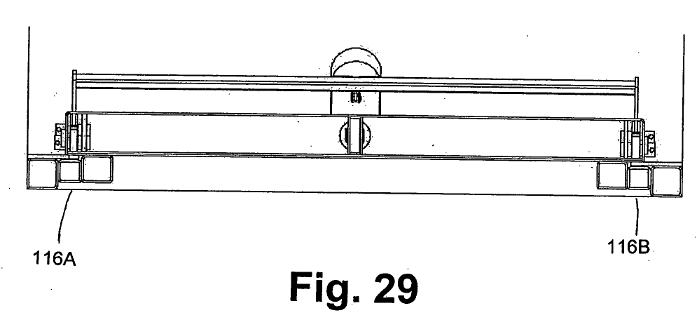

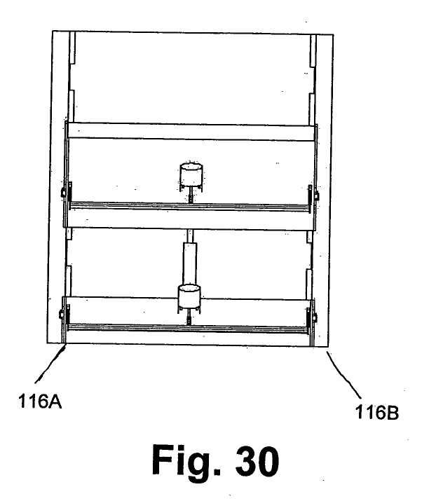

FIGS. 29 and 30 depict various alternative rail configuration. For some uses, a two rail design may be advantageous. Such left and right hand rails 116A and 116B are depicted in front views FIG. 29 and a top view FIG. 30.

In view of the foregoing, it will be seen that the several advantages of the invention are achieved and attained.

The embodiments were chosen and described in order to best explain the principles of the invention and its practical application to thereby enable others skilled in the art to best utilize the invention in various embodiments and with various modifications as are suited to the particular use contemplated.

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

What is claimed is:

1. For a haul vehicle having a rail extending in a longitudinal direction and having a plurality of engagement locations spaced there along, a cyclic traveling system comprising:
a first slide disposed to travel along the rail and having at least one first stop selectively actuated by at least one first actuator, said at least one first stop being configured to selectively engage the rail at one of said engagement locations;
a second slide disposed to travel along the rail and having at least one second stop selectively actuated by at least one second actuator, said at least one second stop being configured to selectively engage the rail at one of said engagement locations;
an extension member connecting said first slide to said second slide and providing extension and retraction of spacing between said first and said second slides; and
a control system operably connected to said extension member and to said first and said second actuators to control actuation of said first and second actuators and the extension and retraction of said extension member such that said cyclic traveling system is selectively movable along the rail.

2. The cyclic traveling system of claim 1, wherein said first and second slides each have guides to resist derailing of said first and second slides during travel along the rail.

3. The cyclic traveling system of claim 2, wherein the extension member is a single-stage hydraulic cylinder.

4. The cyclic traveling system of claim 1, wherein the plurality of engagement locations are concavities formed in said rail.

5. The cyclic traveling system of claim 1, wherein the plurality of engagement locations are convexities formed in said rail.

6. The cyclic traveling system of claim 1, wherein said engagement locations are formed in pairs at selected locations along the rail.

7. The cyclic traveling system of claim 6, wherein said pairs of claim 6 wherein said pairs of engagement locations are oriented transverse to a direction of travel of said cyclic traveling system along the rail.

8. The cyclic traveling system of claim 5, wherein said at least one stop of said first slide comprises two stops.

9. The cyclic traveling system of claim 8, wherein said two stops of said first slide simultaneously engage at least one pair of said engagement locations formed as pairs at selected locations along the rail.

10. The cyclic traveling system of claim 8, wherein said two stops of said first slide or said second slide are connected to be actuated simultaneously by the at least one actuator.

11. The cyclic traveling system of claim 1, wherein said stops are shear pins.

12. The cyclic traveling system of claim 1, wherein said stops are pivoting members having an engagement face disposed to engage one of said engagement locations.

13. The cyclic traveling system of claim 1, wherein said stops are biased into an engagement position wherein said stop engages one of said plurality of engagement locations and wherein said bias may be overcome by a release device, said release device being disposed to remove said stop from said engaged position.

14. The cyclic traveling system of the claim 13, wherein said release device is a solenoid.

15. The cyclic traveling system of claim 1 further comprising a trash guard.

16. The cyclic traveling system of claim 15 wherein said trash guard is a clearing slide disposed to engage the rail such that movement of said clearing slide clears trash from said rail.

17. The cyclic traveling system of claim 5, wherein said stop is configured as a concavity, dimensioned to engage a convex engagement location on the rail.

18. The cyclic traveling system of claim 12, wherein said pivoting stop is disposed to engage a first face of an engagement location to anchor said cyclic traveling system for powered movement in an ejection direction and said pivoting stop being further configured to engage another face of an engagement location to anchor said cyclic traveling system for powered movement in a return direction.

19. The cyclic traveling system of claim 1, wherein in each of said slides is further comprised of a first and second pivoting stop, said first pivoting stop being disposed to anchor said cyclic traveling system for powered movement in an eject direction and said second pivoting stop being configured to anchor said cyclic traveling system for powered movement in an opposite direction.

20. The cyclic traveling system of claim 12, wherein said pivoting stop further comprises a ramp face, said ramp face being disposed to bias said stop out of engagement with an engagement location as said cyclic traveling system travels.

21. The cyclic traveling system of claim 19, wherein each of said first and second pivoting stop is actuated by a separate actuator.

22. The cyclic traveling system of claim 1, wherein said engagement locations are on a top of said rail.

23. The cyclic traveling system of claim 1, wherein said engagement locations are on a side of said rail.

24. The cyclic traveling system of claim 1, further comprising a refuse truck having a body for receiving material, said rail being secured to extend the substantially the length of said body.

25. The cyclic traveling system of claim 24, further comprising a panel corresponding to a cross-section of said body of the refuse truck and secured to the second slide.

26. The cyclic traveling system of claim 24, wherein said refuse truck has a single rail.

27. The cyclic traveling system of claim 24, wherein said refuse truck has dual side rails.

28. The cyclic traveling system of claim 1 wherein the rail is a fixed installation.

29. The cyclic traveling system of claim 1 wherein the rail is straight.

30. The cyclic traveling system of claim 1 having a closed tooth spacing, a stroke length and a slot spacing and wherein said closed tooth spacing plus said stroke length is greater than or equal to said slot spacing multiplied by two.

31. The cyclic traveling system of claim 1 having a tooth length and a slot length and wherein said slot length is greater than or equal to said tooth length.

32. The cyclic traveling system of claim 1 having a closed tooth spacing, and a slot spacing and wherein said slot spacing >said closed tooth spacing.

33. The cyclic traveling system of claim 31 having a tooth length and a slot length and wherein said slot length equals said tooth length plus two inches.

34. The cyclic traveling system of claim 32 having a closed tooth spacing, and a slot spacing and wherein said slot spacing equals said closed tooth spacing plus one inch.

35. The cyclic traveling system of claim 1 having a closed tooth spacing and a stroke length and wherein said stroke length equals said closed tooth spacing plus three inches.

36. The cyclic traveling system of claim 1 further having a tooth length and a slot length, and a gap between said tooth length and said slot length, said gap having length.

37. The cyclic traveling system of claim 36 wherein a stroke length minus three times said gap length equals a closed tooth spacing.

38. The cyclic traveling system of claim 36 wherein a slot spacing equals said gap length plus said closed tooth spacing.

39. A data structure for controlling a cyclic traveling system, said data structure comprising:
an instruction to extend an extension member a preconfigured length;
an instruction to engage a first stop when said extension member has extended said preconfigured length;
an instruction to disengage a second stop when said first stop has been engaged; and
an instruction to retract said extension member a preconfigured length when said second stop has been disengaged.

40. The data structure of claim 39 wherein said instructions to extend, engage, disengage and retract are repeated.

41. The data structure of claim 40 wherein said repetition continues until a sensor in operative communication with said data structure signals an end.

42. The data structure of claim 40 wherein said repetition continues until an operator signals an end through an operator interface in operative communication with said data structure.

43. A method of fabricating a cyclic traveling system comprising:
fabricating a plurality of engagement locations along a rail, the rail defining a first direction;
attaching a first slide member and a second slide member to an extending member such that extension of said extending member increases a distance between said first slide member and said second slide member;
assembling a first actuator with said first slide member and a second actuator with said second slide member such that said first and second slide members may be selectively actuated in a second direction orthogonal to said first direction;
disposing said extending member on said rail with said first and second slide members aligned in said first direction and with at least one of said first or second slide members being actuated in said second direction to be engaged with one of said engagement locations, such that said extending member may be positioned in a driving relation to a load.

44. The device of claim 1 deployed on a scaffolding as a climbing device.

45. The device of claim 1 deployed on a ladder as a climbing device.
